(19) United States
(12) Patent Application Publication
(10) Pub. No.: US 2020/0104838 A1
(43) Pub. Date: Apr. 2, 2020

(54) Method and System For Setting Controls On Assets Transactions

(71) Applicant: Mohamad Majed Sidani, New Canaan, CT (US)

(72) Inventor: Mohamad Majed Sidani, New Canaan, CT (US)

(21) Appl. No.: 16/414,861

(22) Filed: May 17, 2019

Related U.S. Application Data
(60) Provisional application No. 62/739,607, filed on Oct. 1, 2018.

(51) Int. Cl. G06Q 20/38; G06Q 20/40

(52) U.S. Cl. CPC G06Q 20/389; G06Q 20/405

(57) ABSTRACT

A system for verifying transactions is disclosed. A database in data communication with a computer stores an account with holding data. A ledger in data communication with said computer stores a rule indicative of permission to modify the account. When a transaction is received by the computer, software executing on said computer retrieves a rule associated with the account from the ledger based on the transaction. Software executing on said computer also generates a verification of said transaction based on the transaction and the rule. Software executing on the computer transmits the verification.

### TECHNICAL FIELD

This invention relates to a system to set controls on transactions on assets of value held in a bank account, brokerage account, or digital wallet account. Transactions include sales, withdrawals, transfers, or other actions that affect the total value composition or other characteristics of the assets. This invention acts as a gateway to the assets held by providing a standalone, automatic enforcer of computer-coded programs implementing those controls over access to and management of the holdings. The invention can be implemented using distributed ledger or blockchain technology and smart contract technology.

### BACKGROUND

Conventionally, banks, brokerages, and other financial institutions (collectively, “financial institutions”) offering accounts to hold valuable assets and the ability to effect transactions on those accounts have only offered a very restrictive set of controls that can be applied to those accounts. Without proper technology financial institutions can only authorize transactions based on a list of authorized signatories created, maintained, and updated on occasion by the financial institution itself.

Essentially a bank or financial institution could offer the following controls to the account owner(s):

Dual signature requirements, whereby transactions require two signatures of two authorized signatories for transactions to go through.

Transfers limited to certain other accounts and/or payees.

In the case of debit card transactions, controls in the form of constraints on daily or other period's maximum limits are possible.

Examples of controls on brokerage accounts include granting power of attorney to a money manager or an investment advisor.

Nevertheless, not all controls implemented on accounts are strictly enforced. It is very common for financial institutions to clarify in their terms and conditions for opening an account that “dual signature requirements” can be set on the account but not enforced by the financial institution. Additionally, dated technology, security concerns, and administrative burdens make it difficult for the bank to enforce such controls.

Distributed ledger technologies, including blockchains, provide secure, auditable, tamper-proof storage of data, smart contracts, and a historical record of transactions through the use of hard-to-reverse mathematical encryption. This invention allows the implementation of controls without adding an administrative burden to each request.

Requests to modify the distributed ledger or account are called transactions and typically include an electronic signature using cryptographic technology that uniquely identifies the initiator of the request.

### SUMMARY

Accordingly, it is an object of the invention to quell the administrative burden of verifying transactions. The method and system of this invention allow the implementation of controls on assets of value in an account through a flexible, rich, and complex set of computer programs.

Objects of this invention can be solved by implementing distributed ledgers having smart contracts to repositories. An account could be a bank account, brokerage account, digital wallet, or other asset holder. In the account, assets of value are stored, such as units of currency, securities, debt instruments, other financial instruments, or financial derivatives. Collectively, anything stored in the account is holding data. Holding data may also refer to data representative of the contents of the account. Account controls are implemented using computer code without restrictions on the computer language.

The invention allows an account owner to encode controls as rules that govern the use of assets in an account by another person. The account owner who has granted another person access or permissions to the account could, for example, specify an upper daily limit on the amount of cash that person can withdraw. The account holder could also use such an account to block payments to a counterparty.

The technology also allows a business owner to grant access to his/her company's business account to employees while setting sophisticated controls relating to what they are permissioned to do. The permissioning could specify an upper limit on withdrawals by an employee; or it could specify types of transactions another employee is allowed to initiate, for example, purchasing office supplies or factory parts from a list of suppliers stored on the ledger. The banking details for those suppliers could also be encoded on the ledger thereby providing security against fraudulent attacks by computer hackers such as email spoofing.

Co-owners in a legal entity, partners, or shareholders, etc., can use this technology to encode profit distribution mechanisms included in their association/partnership/etc., agreements. The controls could include shares of profits or restrictions on amounts that can be withdrawn. They can also be made contingent on the legal entity meeting some obligations, the meeting of which has to be confirmed first through transactions on the smart contract and encoded in its state. These transactions change the state of the smart contract as reflected for example in the set of pre-conditions affecting certain transactions.

In the case of a brokerage account, or in general an account with many types of holdings, controls can be set for one person to control one type of holding and another person another type of holding. For example, an investment firm such as a hedge fund that manages segregated client accounts could allow one portfolio manager to manage the commodities holdings in the account while tasking another portfolio manager at the firm with managing the equities holdings.

Some of the examples above also apply to online financial wallets, known as digital wallets. Transactions on the online wallet again pass through the smart contract first which reinitiates the transaction on the holdings wallet.

This invention introduces a new type of account, henceforth “smart account”, on which setting automatic controls on the management, disposal, withdrawal, transfer, or other action affecting the account is possible. The smart account comprises two components: an account and a smart contract. A financial services firm can offer and manage this new type of account and its conventional accounts on the same infrastructure.

A smart account in the form of a holdings account is a conventional account for its types of holding. For example, it can be a conventional bank account holding cash or a brokerage account holding securities, bonds, or futures contracts. The smart contract allows new, effective controls to be placed on the account. For instance one control may be only transactions initiated by the smart contract can be executed. Alternatively, transactions initiated by the owner or an authorized party can be executed but only after they have been found not to violate controls in the smart contract or they have been found to be explicitly permitted by the controls in the smart contract.

The transactions are generally of two types: transactions that act on the holdings in the account or transactions for implementing controls on the first type of transaction and that act on the smart contract state, the controls, preconditions and data.

The smart contract contains subcomponents or layers to maintain state and to manage the flow of all transactions. The state may include the pre-conditions and lists of authorized parties, account numbers, and data generally needed by and for the controls. The state may further include a number of pre-encoded common controls or pointers to such controls that are specified by the financial services firm and are loaded by default in the smart contract code and that only require specialization, for example, as to particular parties or amounts. Common controls can be expected to be requested by many account owners or controls the financial institution wants to enforce on all accounts for compliance or regulatory purposes.

Pointers work similarly to links such that the actual controls can be hosted off the smart contract. The pointer in the smart contract will instruct the module reading the blockchain to go to an off smart contract storage to find the actual control. Pointers can help with data storage on the nodes and allows for easier control of basic transaction. Pointers are also beneficial if a firm offers standard transaction controls to every account opened with them. If an account owner did not want a standard control, adding or subtracting a pointer to an off smart contract storage is easier than storing the entire list of standard controls.

The state of the smart contract also includes controls not envisaged initially and are specified by the account's owner(s) or other authorized parties. The pre-encoded controls could be made available to the smart contract by providing pointers and other specialized smart contracts. The smart contract in this latter case initiates a request to the specialized smart contracts to execute or verify the controls. This potentially reduces the amount of new computer code that has to be developed or implemented when a new smart account is opened. This also potentially saves the owner from having to supply computer code for the rule every time the owner wants to modify the set of controls. If the rule is pre-loaded, the blockchain transaction to modify the set of controls would just include an “add rule” order that points to the pre-encoded controls and specifies the required specialization, generally as arguments to the function implementing the rule. The rule can be any limitation or feature, including a control.

The layer or subcomponent containing the state of the smart contract includes data such as information on the owners of the account or other authorized parties and a mapping to permissions for and restrictions on their activities. The state of the smart contract can, for example, include holdings accounts information where certain final transactions are executed. The state also includes the controls governing the transactions. For controls that are pre-loaded and have been activated by the account owner or other authorized parties, only addresses that point to the code implementing the controls are needed for execution. The computer code for these pre-encoded controls could be available explicitly in the smart contract or could be contained in another smart contract running on the blockchain. Controls that have not been envisaged by the financial services firm are programmed and the code is submitted to the smart contract. The smart contract can use a parser and/or an interpreter to execute the code.

Transactions are invoked on the appropriate point of entry. Points of entry are methods on the smart contract. For example, a transaction to transfer funds from the holdings account is invoked on the wire transfer point of entry; a transaction to add a rule is invoked on a point of entry specifically to add controls. One point of entry exists for every type of transaction the financial services firm allows. The output from executing any of the methods varies. For the wire transfer method, a transaction to transfer funds with the appropriate credentials is output and is later executed by the financial services firm's processes on the holdings account. For a transaction to add a rule, the output only needs to be a success or fail code.

A core logic subcomponent manages the overall execution of the smart contract. It contains points of entry for all transactions, one point of entry per type of transaction or per category of transaction allowed. Typically, banking transactions form a single such category. Core logic also contains an interpreter to execute the controls and other utility functions needed in the execution, such as a look-up function to gather data from the blockchain or other databases or systems maintained by the financial services company.

A request by an authorized party for a banking transaction, i.e., a transaction on the holdings such as a withdrawal or sale or transfer, etc., is first routed to a computer system that runs the transaction processes. The banking transaction is then passed to the smart contract through the appropriate point of entry where it is checked for compliance with preconditions encoded in the controls of the smart contract. The smart contract then rejects the banking transaction if the controls are violated or the smart contract will output a new, derivative banking transaction on the holdings account to execute the original transaction. The ledger participates in these inspections and if consensus is reached within the ledger, it is updated irreversibly. The firm's transactions processor can read the updated ledger and executes the output transaction or forwards the rejection back to the requesting party.

The objects of the invention could alternatively be solved without initiating a new banking transaction. The smart contract can output a code to allow or reject the banking transaction and then the firm's transactions processor forwards the rejection to the initiator or allows the processing to proceed as with any conventional banking transaction.

Blockchain transactions are transactions on the state of the smart contract such as adding, modifying, or deleting controls. These affect the controls in the smart contract itself and relate to the creation, deletion, or modification of new or existing controls or to the modification of data or preconditions in the smart contract. Blockchain transactions can also change the pointers in the smart contract. Transactions to modify the set of controls are also checked for preconditions, for example, as to who is permitted to make the changes. Next, based on the check, the transaction is either allowed to proceed or rejected.

Banking transactions affecting the holdings of the account can be of many types: debit card transactions, checks, online transactions, securities sales, cash transfer, etc.

A tamper-proof, complete history of all blockchain transactions on the smart account can be recorded on the ledger that is shared by the account owner(s) and the financial services firm.

Furthermore, controls could specify requirements such as approval by external parties for certain transactions to proceed. Such transactions are commonly known as having multisignature requirements. In this case the communication layer in the smart contract will initiate messages to the approving parties who respond by adding electronic signatures to the transactions in question.

In one aspect of the invention, the system has a database in data communication with a computer and stores an account with holding data. A ledger in data communication with said computer stores a rule indicative of permission to modify the account. When a transaction is received by the computer, software executing on said computer retrieves a rule associated with the account from the ledger based on the transaction. Software executing on said computer also generates a verification of said transaction based on the transaction and the rule. Software executing on the computer transmits the verification.

### BRIEF DESCRIPTION OF THE DRAWINGS

FIG. 1 is a diagram of an embodiment of the transaction verification system.

FIG. 2 is a diagram of an embodiment of the transaction verification system.

FIG. 3 is a flowchart of a transaction on the asset holdings of an account.

FIG. 4 is a flowchart of a transaction on the state of a smart contract.

FIG. 5 is a flowchart of a transaction on the asset holdings of an account.

### DETAILED DESCRIPTION

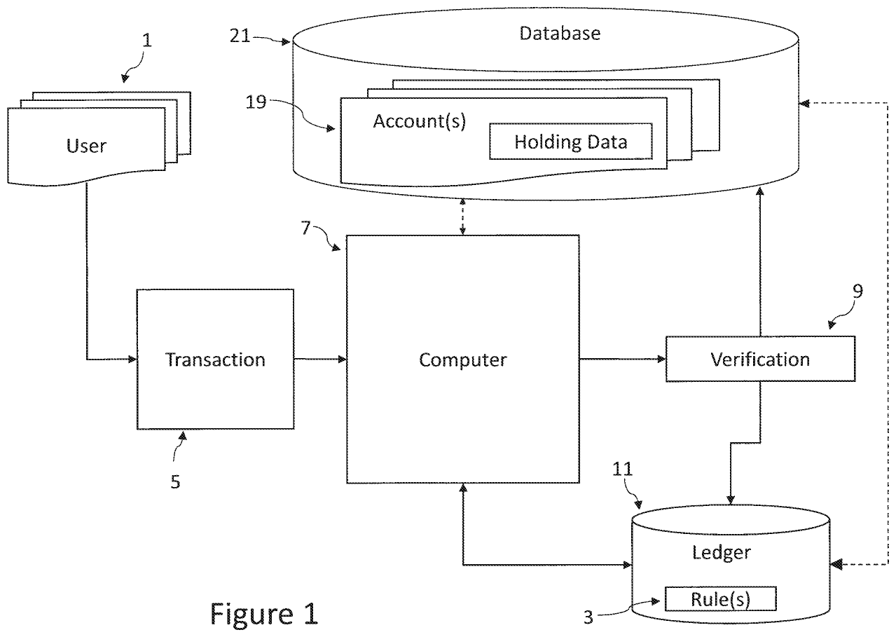

FIG. 1 illustrates the transaction verification system. A user 1 initiates a transaction 5. The transaction 5 will be sent to a computer 7 which will determine the validity of the transaction 5 based on rules 3 on a ledger 11. Verification 9 is generated by computer 7 and sent to the database 21. The computer 7 may also send the verification 9 to the ledger 11.

The rules 3 may be specific to the user 1 or general for an account 19. The computer 7 sends all transactions 5 to the ledger 11. The transaction 5 may be a new rule, or a change of a rule 3 in the ledger 11. When the transaction 5 is a rule, the database 21 may not need to approve the verification 9 for the ledger 11 to be updated with the new rule of transaction 5.

Alternatively, the transaction 5 may be an action on holding data of an account 19. When the transaction 5 is an action on the holding data, the verification is sent to the database 21, which has software to execute the transaction 5, if the verification 9 is valid. If the transaction 5 is invalid, the database 21 will still be informed of the transaction 5. The database 21 may be able to overrule an invalid verification 9. The ledger 11 may indefinitely store the list of transactions 5 which have been made by user 1, including valid transactions, invalid transactions, or both.

The ledger 11 is designed to store and access the rules 3. Each of the rules 3 may apply to accounts 19, only a single user 1 of an account 19, or a select number of users 1 of an account 19. Alternatively, a rule 3 may apply to multiple accounts 19 or multiple users 1. The computer 7 will read the rules 3 from the ledger 11 and thus prevent the bypass of a rule that has been created. The ledger does not need to physically contain an entire list of rules 3. Instead, the ledger 11 may contain pointers such that the computer 7 follows to go to access the rules 3. The rules 3 can be related to the permissions of a user 1 to access the holdings of an account 19, or their ability to change the rules 3 of that account 19. The ledger 11 can be a blockchain. The ledger 11 can be stored on multiple computers at the same time. Each computer storing the ledger 11 may be updated for each transaction 5 or rule 3 sent by user 1, either with just the verification 9 or transaction 5 and the verification 9. The plurality of computers storing the ledger 11 would then come to a consensus on the state of the rules 3 for a transaction 5 to be verified by computer 7.

The database 21 is portrayed separate from the computer 7 and thus the transaction 5 cannot be immediately performed by the computer 7 in this figure. However, it is possible that the computer 7 has permission to perform the transaction 5 on the accounts 19 directly. The database 21 may monitor the ledger to determine when the transaction 5 has been approved. If the database is continuously monitoring the ledger 11 it may not be necessary to send the verification 9 to the database 21.

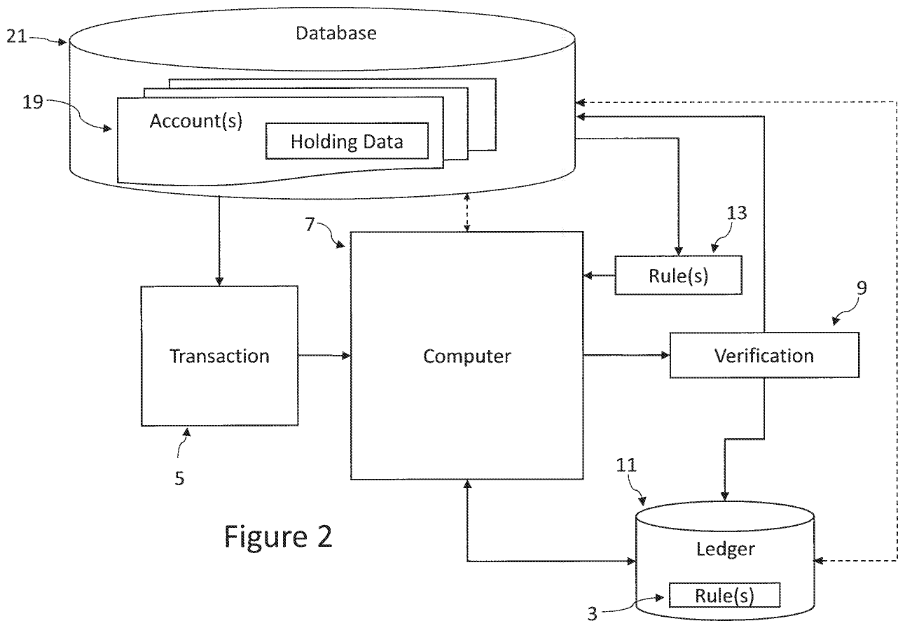

FIG. 2 illustrates a transaction verification system. Here, the database 21 initiates the transaction 5. This may be done by a user 1 communicating through the database 21. For example, the user could login to the database via a terminal. FIG. 2 also shows that database 21 may have its own rules 13 to be applied to the transaction 5. These rules may be sent to the ledger 11, or may be checked by the computer 7 before accessing the ledger 11. It would be appreciated that either or both of these features could be implemented into the system, independently or separately.

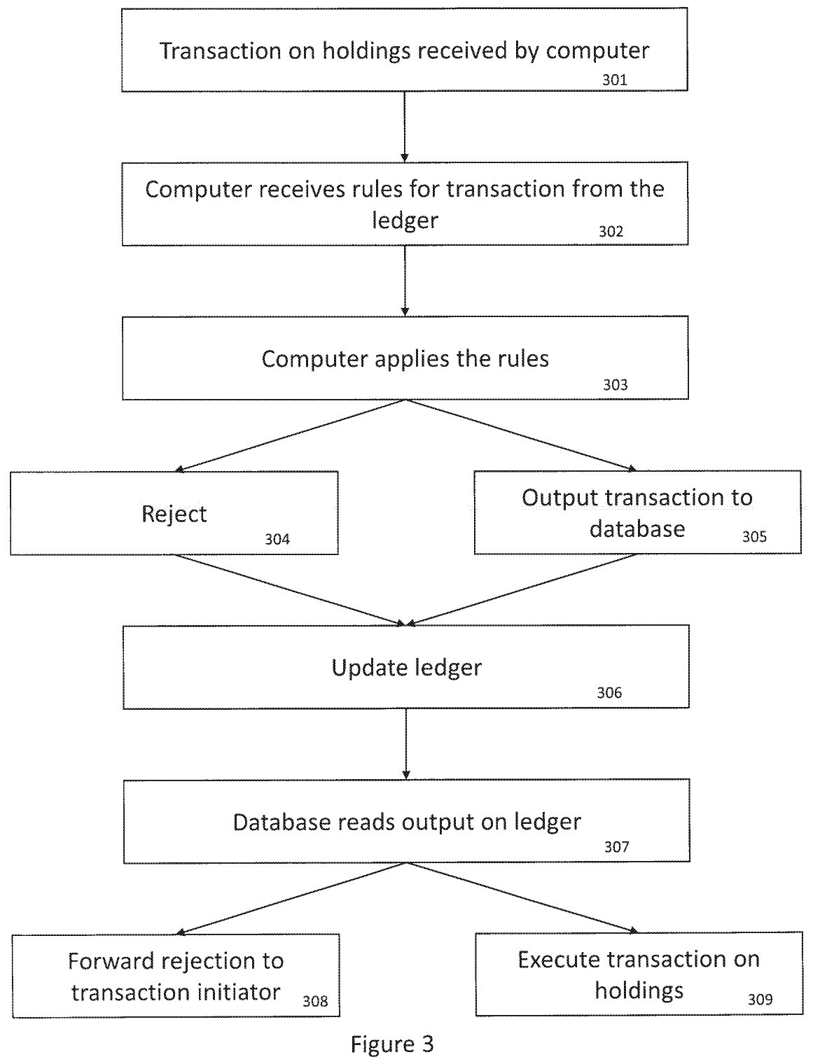

FIG. 3 shows the flow of a banking transaction on the holdings of the account. In this figure, the firm's transactions processor reads the blockchain to determine whether to execute the transaction. In step 301, the transaction has been received by the financial services firm's transactions processor. In step 302, the transactions processor invokes the appropriate entry point for the type of the transaction in the smart contract. In step 303, the smart contract applies the controls that are set in its state to the transaction. If there are no rules on the transaction, the transaction may go through automatically, depending on the user's settings. Step 304 follows if any precondition for an existing rule has been violated. Otherwise, step 305 follows and the smart contract reinitiates the transaction as specified in the applicable controls. In step 306, the blockchain is updated regardless of the previous step. In step 307, the transactions processor, which has been listening to updates on the blockchain, reads the updated blockchain. If the smart contract had rejected the transaction step 308 follows and the rejection is forwarded to the transaction initiator. Otherwise step 309 follows and the transactions processor executes the transaction that was output by the smart contract on the holdings account.

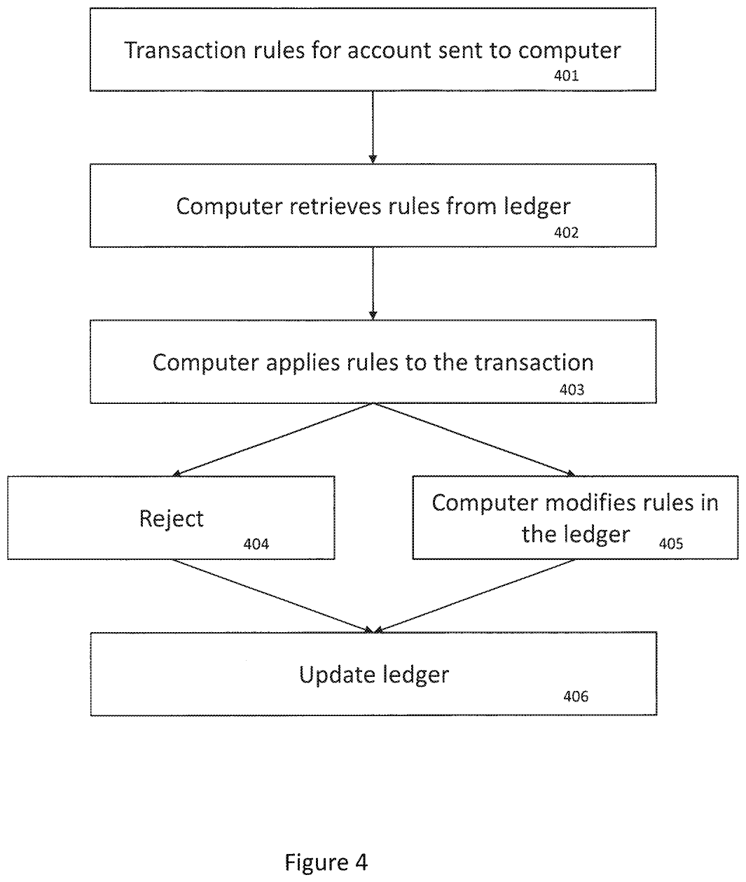

FIG. 4 shows the flow of a transaction on the state of the smart contract. In step 401, the transaction is initiated from one of the nodes supporting the blockchain. In step 402, the transaction is invoked on the appropriate entry point. There is one entry point per type of transaction. For example, when adding controls is permissible, an entry point for adding controls is provided; another entry point could also be added for deleting controls. The financial services firm decides which types of transactions to allow. In step 403, the existing controls governing the transaction are applied. For example, these could check if the party initiating the transaction is authorized to do so. Step 404 follows if controls for the transaction are violated. Otherwise step 405 follows and the set of controls or data or pre-conditions is modified as specified. Finally in step 406 the blockchain is updated and contains the updated smart contract if the controls were changed.

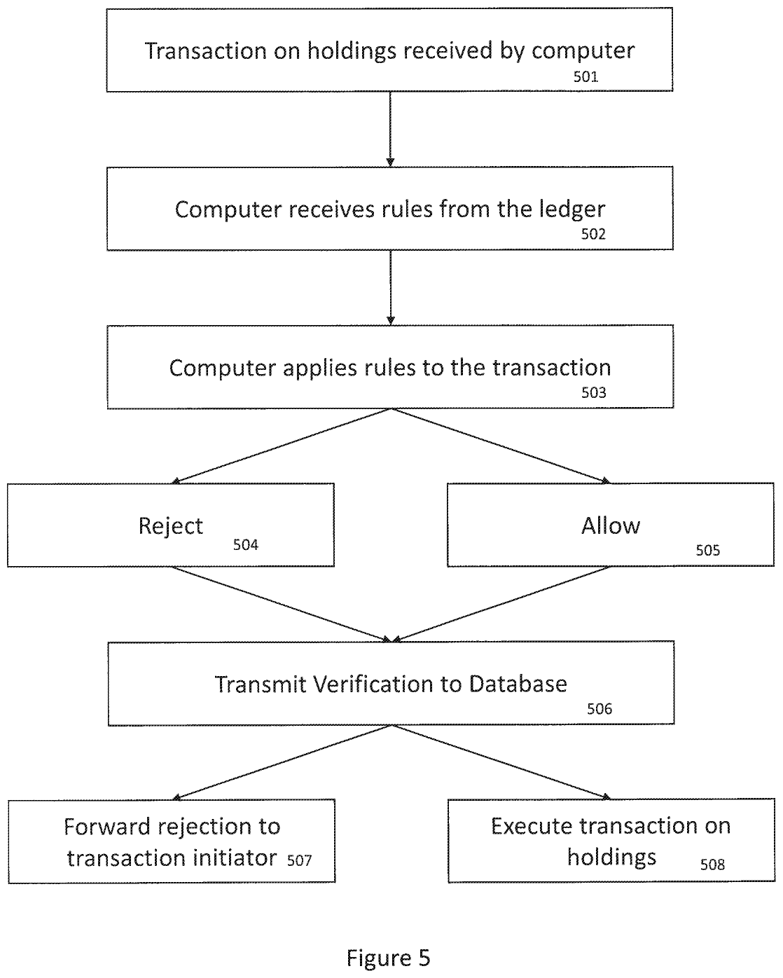

FIG. 5 shows the flow of a transaction on the holdings of the account. In this figure, the nodes tell the core system directly whether to execute the transaction. In step 501, the transaction has been received by the financial services firm's transactions processor. In step 502, the transactions processor invokes the appropriate entry point for the type of the transaction in the smart contract. In step 503, the smart contract applies the controls that are set in its state, if any. Step 504 follows if any precondition for an existing control has been violated. Otherwise in step 505, the smart contract approves the transaction. In step 506, the transactions processor reads the output. Step 507 follows if the smart contract had rejected the transaction otherwise in step 508, the transactions processor executes the transaction.

What is claimed is:

1. A system for verifying transactions, comprising:
a computer;
a database in data communication with said computer for storing an account, the account including holding data;
a ledger in data communication with said computer for storing a rule indicative of a permission to modify the account;
a transaction received by said computer;
software executing on said computer for retrieving a rule associated with the account from said ledger based on the transaction;
software executing on said computer for generating a verification of said transaction based on the transaction and the rule; and
software executing on said computer for transmitting said verification.

2. The transaction verification system of claim 1, wherein the transaction is a banking transaction.

3. The transaction verification system of claim 2, wherein the verification is transmitted to the database.

4. The transaction verification system of claim 2, wherein the verification is transmitted to the ledger.

5. The transaction verification system of claim 1, wherein the transaction includes a rule indicative of a permission to modify holding data.

6. The transaction verification system of claim 5, wherein the verification is transmitted to the database.

7. The transaction verification system of claim 5, wherein the verification is transmitted to the ledger.

8. The transaction verification system of claim 1, wherein the transaction is transmitted to the computer by a user of the account.

9. The transaction verification system of claim 1, wherein the account has a plurality of rules, each indicative of a permission to modify the account, and each rule is associated with a user of the account.

10. The transaction verification system of claim 9, further comprising a plurality of accounts, each account having at least one rule indicative of permission to modify the account.

11. The transaction verification system of claim 10 wherein each account stored in the database has a corresponding ledger.

12. The transaction verification system of claim 1 further comprising a plurality of computers each having a ledger in data communication with said computer for storing a rule indicative of a permission to modify the account,
each computer comprising software for retrieving a rule associated with the account from said ledger based on the transaction, software executing for generating a verification of said transaction based on the transaction and the rule;
wherein the plurality of computers are in data communication with each other and come to a consensus on a verification of said transaction.

13. The transaction verification system of claim 1 wherein the ledger is a blockchain.

14. The transaction verification system of claim 1 further comprising a second rule stored on the database.

15. The transaction verification system of claim 14 wherein the second rule is received by the computer and stored on the ledger.

16. The transaction verification system of claim 1 wherein the transaction includes a second rule and software executing on said computer for storing the second rule on the ledger.

17. The transaction verification system of claim 1, wherein a transaction is verified if there is no rule related to the transaction.

18. The transaction verification system of claim 1, wherein the transaction is received by the computer from the database.

19. The transaction verification system of claim 18, wherein the database is associated with a financial firm.

20. The transaction verification system of claim 19, wherein the database monitors the ledger to determine the verification of the transaction.
